(19) United States
(12) Patent Application Publication
(10) Pub. No.: US 2020/0145125 A1
(43) Pub. Date: May 7, 2020

(54) COMMUNICATION MODE CONTROL METHOD AND DEVICE

(71) Applicant: SZ DJI TECHNOLOGY CO., LTD., Shenzhen (CN)

(72) Inventors: Naibo WANG, Shenzhen (CN); Xiaojun YIN, Shenzhen (CN); Ning MA, Shenzhen (CN)

(21) Appl. No.: 16/734,716

(22) Filed: Jan. 6, 2020

Related U.S. Application Data
(63) Continuation of application No. PCT/CN2017/095324, filed on Jul. 31, 2017.

(51) Int. Cl. H04L 1/00; H04L 5/14; H04W 72/04; H04B 1/10; H04B 17/309; H04W 72/08

(52) U.S. Cl. CPC H04L 1/0003; H04L 1/0026; H04L 5/14; H04W 72/042; H04W 72/082; H04W 72/0446; H04B 1/1027; H04B 17/309; H04W 72/0453

(57) ABSTRACT

A communication mode control method is provided for a communication device. The method includes obtaining a channel parameter of at least one communication channel between two communication parties; according to the channel parameter of the at least one communication channel, determining a first measurement parameter of communication quality for communication between the communication parties using a time division duplex mode and determining a second measurement parameter of communication quality for communication between the communication parties using a frequency division duplex mode; and according to the first measurement parameter and the second measurement parameter, determining whether the communication parties communicate using the time division duplex mode or using the frequency division duplex mode.

### CROSS-REFERENCE TO RELATED APPLICATION

This application is a continuation of International Application No. PCT/CN2017/095324, filed Jul. 31, 2017, the entire content of which is incorporated herein by reference.

### COPYRIGHT NOTICE

A portion of the present disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of communication technology and, more particularly, to a method and device for communication mode control.

### BACKGROUND

When two communication parties communicate using the same physical medium, the parties can receive and send data simultaneously through the duplex communication mode.

In the existing technologies, the duplex communication is realized by time division duplex (TDD) or frequency division duplex (FDD) between two communication parties. TDD is a time division method and uses time to separate signals of data transmission in different directions. FDD is a frequency division method and uses frequency to separate signals of data transmission in different directions. Usually, the two parties use TDD mode for duplex communication on an unlicensed frequency band. However, TDD mode does not take full advantage of the resource of the unlicensed frequency band in frequency, which causes low resource utilization rate of the unlicensed frequency band.

### SUMMARY

In accordance with the present disclosure, a communication mode control method is provided for a communication device. The method includes obtaining a channel parameter of at least one communication channel between two communication parties; according to the channel parameter of the at least one communication channel, determining a first measurement parameter of communication quality for communication between the communication parties using a time division duplex mode and determining a second measurement parameter of communication quality for communication between the communication parties using a frequency division duplex mode; and according to the first measurement parameter and the second measurement parameter, determining whether the communication parties communicate using the time division duplex mode or using the frequency division duplex mode.

Also in accordance with the present disclosure, a communication device includes one or more processors that work individually or cooperatively. The one or more processors are operable when executing certain program instructions to obtain a channel parameter of at least one communication channel between two communication parties; according to the channel parameter of the at least one communication channel, determine a first measurement parameter of communication quality for communication between the communication parties using a time division duplex mode and determine a second measurement parameter of communication quality for communication between the communication parties using a frequency division duplex mode; and according to the first measurement parameter and the second measurement parameter, determine whether the communication parties communicate using the time division duplex mode or using the frequency division duplex mode.

### BRIEF DESCRIPTION OF THE DRAWINGS

FIG. 1 is a schematic flow chart of a communication mode control method according to an exemplary embodiment of the present invention;

FIG. 2 is a schematic network structural diagram configured for a communication mode control method according to another exemplary embodiment of the present invention;

FIG. 3 is a schematic structural diagram of a communication device according to another exemplary embodiment of the present invention; and

FIG. 4 illustrates a schematic structural diagram of an unmanned aerial vehicle (UAV) according to another exemplary embodiment of the present invention.

### REFERENCE NUMERALS IN DRAWINGS

| | | | |
|---|---|---|---|
| 20 | Unmanned aerial vehicle (UAV) | 21 | Remote control |
| 22 | Ground base station | 30 | Communication device |
| 31 | Processor | 32 | Communication interface |
| 100 | UAV | 102 | Supporting device |
| 104 | Photographing device | 106 | Propeller |
| 107 | Motor | 108 | Sensing system |
| 110 | Communication system | 112 | Ground station |
| 114 | Antenna | 116 | Electromagnetic waves |
| 117 | Electronic speed regulator | 118 | Flight controller |

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Exemplary embodiments will be described with reference to the accompanying drawings, in which the same numbers refer to the same or similar elements unless otherwise specified. Features in various embodiments may be combined, when there is no conflict.

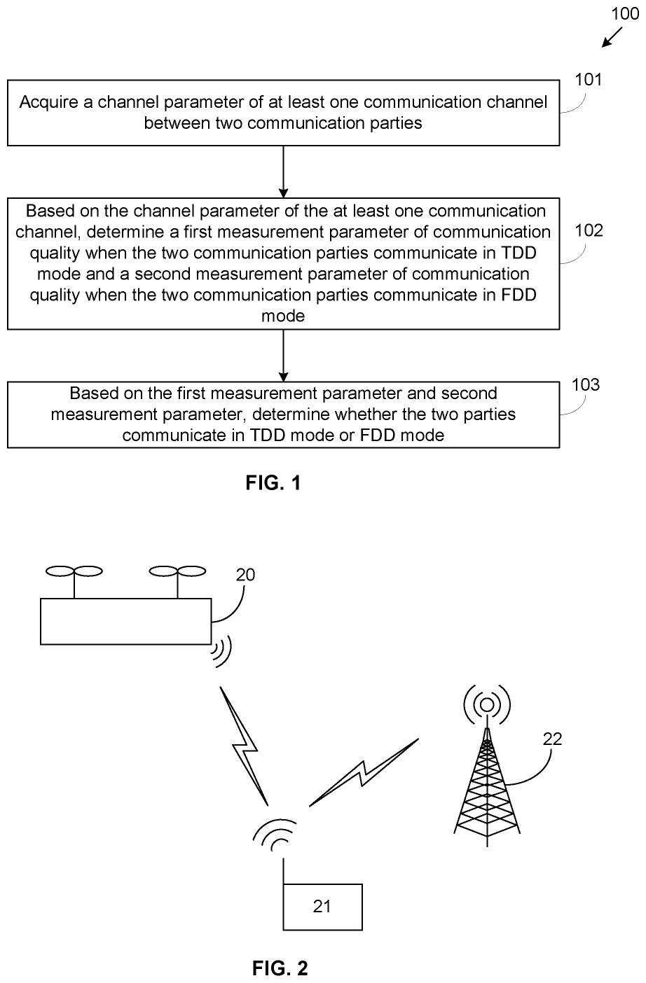

The present disclosure provides a method for communication mode control. FIG. 1 illustrates a schematic flow chart 100 of an exemplary method for communication mode control consistent with the present disclosure. As shown in FIG. 1, the exemplary method may include the following steps.

At step 101, a channel parameter(s) of at least one communication channel between two communication parties may be obtained.

The executing entity of the method of the embodiment may be any one of the two communication parties. Wireless communication is performed by both communication parties. In some embodiments, the two communication parties may be any two of an unmanned aerial vehicle (UAV), a remote control device, or a ground base station. The two communication parties may also be any one of a UAV-UAV group, a remote control device-remote control device group, or a ground base station-ground base station group.

FIG. 2 illustrates schematically a network structural diagram configured for a communication mode control method consistent with the present disclosure. As shown in FIG. 2, a UAV 20 may wirelessly communicate with a remote control device 21 and the remote control device 21 may wirelessly communicate with a ground base station 22. In some embodiments, the UAV 20 may wirelessly communicate with the ground base station 22 directly. In one embodiment, the ground base station 22 may be a real-time kinematic (RTK) positioning base station, which may be used to transmit RTK data to the UAV 20 or the remote control device 21. In one application scenario, the UAV 20 may receive RTK data broadcasted by an RTK base station through radio communication interface. In another application scenario, the ground base station 22, for example, an RTK base station, may send RTK data to the remote control device 21, the remote control device 21 may send the RTK data to the UAV 20, and the UAV 20 may receive the RTK data transmitted by the remote control device 21 through an wireless network communication interface. A processor of the UAV 20, such as a flight controller, may determine the location information of the UAV 20 based on the RTK data received by the UAV 20 and satellite signals received from a satellite by the UAV 20.

Above discussions are just illustrative explanations, which do not limit any specific application scenarios. For example, in some other embodiments, the UAV 20 may also send the captured image information or video data to the remote control device 21, and the remote control device 21 may further send the image information or video data to the ground base station 22. At this time, the ground base station 22 may be a wireless base station. Alternatively, in some other embodiments, the number of UAVs 20 may be more than one. For example, any two among multiple UAVs may wirelessly communicate with each other. Similarly, any two among multiple remote control devices or any two among multiple ground base stations may wirelessly communicate with each other. In some embodiments, two communications parties may communicate in duplex mode during wireless communication. In some embodiments, the duplex mode may include at least one of time division duplex (TDD) or frequency division duplex (FDD).

The above-described embodiment takes an example of a UAV and a remote control device to illustrate the communication mode control method between communication parties. Specifically, there may be at least one communication channel between a UAV and a remote control device. The at least one communication channel may be a frequency band or frequency point of an unlicensed band. For example, a UAV may communicate with a remote control device on a 2.4G frequency band or a 5G frequency band, and may also communicate on the 2.4G frequency band and the 5G frequency band at the same time. In addition, unlicensed frequency bands may not be limited to 2.4G and 5G frequency bands, but may also include other frequency bands.

Any one of the two communication parties may acquire channel parameters of at least one communication channel between the parties. For example, a UAV or a remote control device may obtain channel parameters of at least one communication channel between the UAV and the remote control device. The channel parameters of the communication channel may include at least one of the maximum transmit power of the communication channel, the path loss of the communication channel, or the interference level of the communication channel.

The maximum transmit power is different for different bands. For example, in Europe, 5.8G has a power limit of 25 mW and 2.4G has a power limit of 100 mW. In some embodiments, a UAV or remote control device may obtain maximum transmit power of at least one communication channel among communication channels according to the transmit power permitted on different frequency bands in an area of the UAV or the remote control device. Alternatively, a UAV or remote control device may determine the positioning information about the UAV or the remote control device according to a positioning device, and further determine the area of the UAV or the remote control device according to the positioning information, and further obtain the maximum transmit power of different frequency bands specified in the area. The path loss and interference level of a communication channel between a UAV and a remote control device may be obtained by measuring the physical layer between the UAV and the remote control device.

In some embodiments, a UAV or remote control device supports TDD and FDD modes on hardware. The communication channel between a UAV and a remote control device may include at least one of a 2.4G frequency band or a 5G frequency band, but not be limited to this. In some other embodiment, a communication channel between a UAV and a remote control device may also include a 24G frequency band.

For example, a UAV and a remote control device may communicate in FDD mode on the 2.4G and 5G frequency bands, also may communicate in TDD mode on the 2.4G frequency band, and also may communicate in TDD mode on the 5G frequency band. The schematic descriptions above and below do not define a specific communication frequency band or frequency point, nor do it limit the number of communication bands or frequency points.

At step 102, based on the channel parameter of the at least one communication channel, it may be arranged to determine a first measurement parameter(s) of the communication quality when the communication parties communicate in TDD mode and a second measurement parameter(s) of communication quality when the communication parties communicate in FDD mode.

For example, communication channels between a UAV and a remote control device may include a 2.4G frequency band or a 5G frequency band. According to the channel parameter of the 2.4G frequency band or 5G frequency band, the UAV or remote control device may determine the communication quality for communication between the two parties in TDD mode on the 2.4G frequency band or 5G frequency band, and the communication quality for communication between the two parties in FDD mode on the 2.4 G frequency band or 5G frequency band. Measurement parameters of communication quality may include at least one of a signal interference noise ratio or a data throughput, hereinafter the signal interference noise ratio may be called signal-to-noise ratio and the data throughput may be called throughput.

In some embodiments, in order to distinguish the communication quality for communication between two parties in TDD mode communicating on the 2.4G or 5G frequency band, and communication quality for communication between two parties in FDD mode on the 2.4G or the 5G frequency band, the measurement parameter of communication quality is recorded as the first measurement parameter when two parties communicate in TDD mode on the 2.4G or 5G frequency band, and the measurement parameter of communication quality is recorded as the second measurement parameter when two parties communicate in FDD mode on the 2.4G or 5G frequency band.

Specifically, the first measurement parameter may include a measurement parameter of communication quality when two communication parties communicate in TDD mode on the 2.4G frequency band and/or a measurement parameter of communication quality when two communication parties communicate in TDD mode on the 5G frequency band. The second measurement parameter may include the measuring parameter of communication quality when one of the two communication parties uses the 2.4G frequency band as the uplink frequency band and the 5G frequency band as the downlink frequency band in FDD mode, and/or when one of the two communication parties uses the 2.4G frequency band as the downlink frequency band and the 5G frequency band as the uplink frequency band in FDD mode.

At step 103, based on the first measurement parameter and second measurement parameter, determining whether the two parties communicate in TDD mode or FDD mode.

A UAV or remote control device may compare the first measurement parameter with the second measure parameter. If the first measurement parameter is greater than the second measurement parameter, it indicates that the communication quality is higher when the communication parties use TDD mode to communicate. As such, communication in TDD mode between the communication parties, namely the UAV and the remote control device, may be determined. If the first measurement parameter is less than the second measurement parameter, it indicates that the communication quality is higher when the communication parties use FDD mode to communicate. Hence, communication in FDD mode between the communication parties, namely the UAV and the remote control device, may be determined.

For TDD mode, configurations of selected communication channels may include a frequency point, a bandwidth, and uplink and downlink time slot allocation.

It may be understood that before one communication party acquires channel parameters of a communication channel, a connection has been established between the two communication parties. There is no limit on the communication mode used by the communication parties when the communication parties establish a connection. In some embodiments, the communications parties may establish communication connections in a pre-agreed manner. The pre-agreed mode of the communication may be FDD mode, TDD mode, or other communication modes.

In some embodiments, communication between the communication parties may be first established by using TDD mode to establish communication connection and work normally. This is mainly to ensure that the communication connection can be established normally. After the connection is established, previous steps 101-103 may be performed. According to step 103, a UAV or remote control device may determine whether the communication quality is higher when the communication parties communicate in TDD mode, or the communication quality is higher when the communication parties communicate in FDD mode. If the UAV or remote control device determines the communication quality is higher when the communication parties communicate in FDD mode, the UAV or remote control device may switch current TDD mode to FDD mode by means of signaling handshake.

In addition, if the UAV or remote control device determines the communication quality is higher when the communication parties communicate in TDD mode, the UAV or remote control device may further determine by comparison whether the frequency band corresponding to the present TDD mode and the frequency band corresponding to the ascertained TDD mode with higher communication quality are consistent. For example, the communication parties currently communicate in TDD mode on 2.4G frequency band. But based on above-described steps, the communication quality is higher when the communication parties communicate in TDD mode on 5G frequency band. As such, the TDD mode of 2.4G frequency band may be switched to the TDD mode of 5G frequency band.

In some other embodiments, in order to avoid frequent duplex mode switching, a hysteresis threshold may be set. Only when the new duplex mode is superior to the current duplex mode to a certain extent, for example, when it is determined via the above-described steps that the second measurement parameter of communication quality in the FDD mode is greater than the current measurement parameter of communication quality in the TDD mode by a certain threshold, the UAV and the remote control device may switch the current TDD mode to FDD mode by means of a signaling handshake.

In some embodiments, channel parameters of at least one communication channel between the communication parties may be acquired by one of the communication parties. Based on the channel parameters of at least one communication channel, a first measurement parameter of communication quality for communication between the parties in TDD mode may be determined. Additionally, a second measurement parameter of communication quality for communication between the parties in FDD mode may also be determined. By comparing the first measurement parameter and the second measurement parameter, it may be determined whether the parties may communicate in TDD mode or FDD mode. Then, the current duplex mode adopted by the communication parties may be switched to a duplex mode with higher communication quality, so as to make full use of the resource of the unlicensed frequency band and to improve the resource utilization rate of the unlicensed frequency band.

One embodiment of the present disclosure provides a communication mode control method. At step 102 as shown in FIG. 1 and according to channel parameters of the at least one communication channel, determining the first measurement parameter of communication quality for communication between parties in TDD mode may include several implementations as follows.

In one implementation, according to the maximum transmit power, path loss, and interference level of each communication channel of at least one communication channel, the signal-to-noise ratio of each communication channel for communication between the parties in TDD mode may be determined.

Specifically, determining the signal-to-noise ratio of a communication channel according to the maximum transmit power, path loss, and interference level of the communication channel may be obtained by formula (1) below.

SINR(dB)=Tx_Power(dBm)−Path_Loss(dB)−Interference(dBm) (1)

where SINR(dB) is signal-to-noise ratio, Tx_Power(dBm) is maximum transmit power, Path_Loss(dB) is path loss, and Interference(dBm) is interference level.

In some embodiments, a UAV and a remote control device may communicate in TDD mode on the 2.4G frequency band, and also may communicate in TDD mode on the 5G frequency band. Correspondingly, the UAV or remote control device may acquire the maximum transmit power, path loss, interference level for 2.4G and 5G frequency bands, respectively. Based on formula (1) and the maximum transmit power, path loss, and interference level of the 2.4G frequency band, the signal-to-noise ratio may be calculated for communication between the parties in TDD mode on the 2.4G frequency band. Similarly, based on formula (1) and the maximum transmit power, path loss, and interference level of the 5G frequency band, the signal-to-noise ratio may be calculated for communication between the parties in TDD mode on the 5G frequency band.

Further, a target channel may be determined from the at least one communication channel so that the signal-to-noise ratio is maximal for communication between the parties in TDD mode on the target channel.

A UAV or a remote control device may determine a target channel between the 2.4G and 5G frequency bands so that the signal-to-noise ratio is maximal for communication between the parties in TDD mode on the target channel. If the signal-to-noise ratio for communication between the parties in TDD mode on the 5G frequency band is greater than the signal-to-noise ratio for communication between the parties in TDD mode on the 2.4G frequency band, the 5G frequency band may be determined as the target channel. Conversely, the 2.4G frequency band may be determined as the target channel in the opposite scenario.

In another implementation method, according to the maximum transmit power, path loss, interference level, and duty ratio of each communication channel of the at least one communication channel, the throughput of each communication channel for communication between the parties in TDD mode may be determined.

Based on the maximum transmit power, path loss, and interference level of the communication channel, the specific method of determining the throughput of a communication channel may include determining the signal-to-noise ratio of the communication channel as shown in the formula (1) according to the maximum transmission power, path loss, and interference level of the communication channel; and determining the throughput of the communication channel according to the signal-to-noise ratio and the duty ratio of the communication channel, as shown in formula (2).

Throughput(Mbps)=func(SINR)*Resource_Ratio (2)

where Throughput(Mbps) is throughput, func(SINR) is mapping function of signal-to-noise ratio, and Resource_Ratio is duty ratio of the communication channel.

In some embodiments, a UAV and a remote control device may communicate in TDD mode on the 2.4G frequency band, and also may communicate in TDD mode on the 5G frequency band. Correspondingly, the UAV or remote control device may acquire the maximum transmit power, path loss, interference level for the 2.4G and 5G frequency bands, respectively. Based on formulas (1) and (2) and the maximum transmit power, path loss, and interference level of the 2.4G frequency band, the throughput may be calculated for communication between the parties in TDD mode on the 2.4G frequency band. Similarly, based on formulas (1) and (2) and the maximum transmit power, path loss, and interference level of the 5G frequency band, the throughput may be calculated for communication between the parties in TDD mode on the 5G frequency band.

Further, a target channel may be determined from the at least one communication channel so that the throughput is maximal for communication between the parties in TDD mode on the target channel.

A UAV or a remote control device may determine a target channel between the 2.4G and 5G frequency bands so that the throughput is maximal for communication between the parties in TDD mode on the target channel. If the throughput for communication between the parties in TDD mode on the 5G frequency band is greater than the throughput for communication between the parties in TDD mode on the 2.4G frequency band, the 5G frequency band may be determined as the target channel. Conversely, the 2.4G frequency band may be determined as the target channel in the opposite scenario.

Further, the duty ratio of the uplink direction and the duty ratio of the downlink direction of each communication channel may be determined so that the throughput is maximal when the parties communicate in TDD mode on the communication channel.

According to formula (2), the throughput is different for the same frequency band, such as the 2.4G or 5G frequency band, if the duty ratio is different. If the 2.4G frequency band is the target channel, the optimal uplink duty ratio and the optimal downlink duty ratio of the 2.4G frequency band may be determined by adjusting the duty ratios of the uplink and downlink directions on the 2.4G frequency band. As such, the throughput is maximal for communication between the parties in TDD mode on the 2.4G frequency band. Similarly, if the 5G frequency band is the target channel, the optimal uplink duty ratio and the optimal downlink duty ratio of the 5G frequency band may be determined, leading to the maximum throughput for communication between the parties in TDD mode on the 5G frequency band.

In some other embodiments, communication channels between a UAV and a remote control device may also include the 24G frequency band. Specifically, a target channel may be determined among the 2.4G, 5G, and 24G frequency bands. The optimal duty ratio of each frequency band may be determined by adjusting the duty ratio of each frequency band, and the optimal duty ratio of the target frequency band may be determined at the same time.

In one embodiment, by calculating the signal-to-noise ratio or throughput on different communication channels, a target channel may be determined among the communication channels, and consequently, when the parties communicate in TDD mode on the target channel, the signal-to-noise ratio may be maximal. In addition, the optimal duty ratio of the target channel may be determined by adjusting the duty ration of the target channel. Hence, communication quality between the parties may be optimized further. As such, by determining a target channel and the optimal duty ratio of the target channel, the communication quality between the parties in TDD mode may be optimized.

One embodiment of the present disclosure provides a communication mode control method. At step 102 as shown in FIG. 1 and according to channel parameters of the at least one communication channel, determining the second measurement parameter of communication quality for communication between parties in FDD mode may include several implementations as follows.

In one implementation, an uplink channel and a downlink channel are selected from the at least one communication channel. The communication parties communicate in FDD mode on the uplink channel and the downlink channel. According to channel parameters of the uplink channel, the signal-to-noise ratio of the uplink direction may be determined. Similarly, according to channel parameters of the downlink channel, the signal-to-noise ratio of the downlink direction may be determined.

In some embodiments, communication channels between a UAV and a remote control device may include the 2.4G frequency band, 5G frequency band, and 24G frequency band. Two bands may be selected as the uplink channel and downlink channel among the 2.4G, 5G, and 24G frequency bands by the UAV and remote control device. The UAV and the remote control device may communicate in FDD mode on the uplink channel and downlink channel. Specific selection methods of the uplink channel and downlink channel may include various permutations and combinations for the 2.4G frequency band, 5G frequency band, and 24G frequency band. For example, using the 2.4G frequency band as the uplink channel and the 5G band as the downlink channel is only one of the various permutations and combinations. Specifically, various permutations and combinations of the 2.4G band, 5G band, and 24G band may include the following scenarios.

In a first scenario, the 2.4G frequency band is used as the uplink channel, and the 5G frequency band is used as the downlink channel.

In a second scenario, the 2.4G frequency band is used as the downlink channel, and the 5G frequency band is used as the uplink channel.

In a third scenario, the 2.4G frequency band is used as the uplink channel, and the 24G frequency band is used as the downlink channel.

In a fourth scenario, the 2.4G frequency band is used as the downlink channel, and the 24G frequency band is used as the uplink channel.

In a fifth scenario, the 5G frequency band is used as the uplink channel, and the 24G frequency band is used as the downlink channel.

In a sixth scenario, the 5G frequency band is used as the downlink channel, and the 24G frequency band is used as the uplink channel.

For each permutation or combination, the signal-to-noise ratio of the uplink channel may be determined based on channel parameters of the uplink channel. The signal-to-noise ratio of the downlink direction may be determined according to channel parameters of the downlink channel. The signal-to-noise ratio may be calculated according to formula (1), which is not repeated here.

Further, a target uplink channel and a target downlink channel may be determined from the at least one communication channel. When the communication parties communicate in FDD mode on the target uplink channel and the target downlink channel, the difference between the signal-to-noise ratio of the uplink direction and a preset signal-to-noise ratio is maximal, and the difference between the signal-to-noise ratio of the downlink direction and another preset signal-to-noise ratio is maximal.

For example, in the first scenario, the signal-to-noise ratio of the uplink direction may be greater than a preset signal-to-noise ratio threshold, and the signal-to-noise ratio of the downlink direction may be greater than another preset signal-to-noise ratio threshold. In the third scenario, the signal-to-noise ratio of the uplink direction may be greater than a preset signal-to-noise ratio threshold, and the signal-to-noise ratio of the downlink direction may be greater than another preset signal-to-noise ratio threshold. In several other scenarios, the signal-to-noise ratios of the uplink direction may be less than the preset signal-to-noise ratio thresholds, and/or the signal-to-noise ratios of the downlink direction may be less than the preset signal-to-noise ratio thresholds. However, the extent to which a signal-to-noise ratio of an uplink direction is greater than a preset signal-to-noise ratio threshold in the first scenario may be different from the extent to which a signal-to-noise ratio of an uplink direction is greater than a preset signal-to-noise ratio threshold in the third scenario.

In addition, the extent to which a signal-to-noise ratio of a downlink direction is greater than a preset signal-to-noise ratio threshold in the first scenario may be different from the extent to which a signal-to-noise ratio of a downlink direction is greater than a preset signal-to-noise ratio threshold in the third scenario. In the third scenario, when a difference between a signal-to-noise ratio of the uplink direction and a preset signal-to-noise ratio is maximal, that is, the extent to which the signal-to-noise ratio of the uplink direction is greater than the preset signal-to-noise ratio threshold in the third scenario is maximal, and a difference between a signal-to-noise ratio of the downlink direction and another preset signal-to-noise ratio is maximal, that is, the extent to which the signal-to-noise ratio of the downlink direction is greater than the preset signal-to-noise ratio threshold in the third scenario is maximal, the 2.4G frequency band may be determined as the target uplink channel, the 24G frequency band may be determined as the target downlink channel, namely, the 2.4G frequency band may be the optimal uplink channel and the 24G frequency band may be the optimal downlink channel when the parties communicate in FDD mode.

In some embodiments, a target uplink channel and a target downlink channel may be determined from the at least one communication channel. As such, a difference between the signal-to-noise ratio of the uplink direction and the signal-to-noise ratio of the downlink direction may be within a preset range for communication between the parties in FDD mode on the target uplink channel and the target downlink channel. Additionally, the data throughput of the uplink direction is maximal and the data throughput of the downlink direction is also maximal.

Specifically, another method to determine a target uplink channel and a target downlink channel may include ensuring that the signal-to-noise ratio of the uplink direction is equal to or similar to the signal-to-noise ratio of the downlink direction, and making the throughput maximized. For example, in regard to the above six scenarios, when a difference between the signal-to-noise ratios of the uplink direction and the downlink direction in the third scenario is within a preset range compared to other scenarios, it may indicate that the signal-to-noise ratios of the uplink direction and the downlink direction in the third scenario may be equal or similar, and the data throughput of the uplink direction and the data throughput of the downlink direction may be maximal. Hence, the 2.4G frequency band may be determined as the target uplink channel, the 24G frequency band may be determined as the target downlink channel, namely, the 2.4G frequency band may be the optimal uplink channel and the 24G frequency band may be the optimal downlink channel for communication between the parties in FDD mode.

In some other embodiments, an uplink channel and a downlink channel may be selected from the at least one communication channel. The communication parties communicate in FDD mode on the uplink and the downlink channels. The data throughput of the uplink direction may be determined according to channel parameters of the uplink channel. The data throughput of the downlink direction may be determined according to the channel parameters of the downlink channel.

The six scenarios are mentioned above for illustration. For each permutation or combination, the signal-to-noise ratio of the uplink direction may be determined according to channel parameters of the uplink channel. Further, the data throughput of the uplink direction may be determined according to the signal-to-noise ratio of the uplink direction. Similarly, the signal-to-noise ratio of the downlink direction may be determined according to channel parameters of the downlink channel. Further, the data throughput of the downlink direction may be determined according to the signal-to-noise ratio of the downlink direction. Calculation of the signal-to-noise ratio may refer to formula (1) and calculation of the data throughput may refer to formula (2), which are not repeated here.

Further, after the target uplink channel and the target downlink channel are determined from the at least one communication channel, the communication parties may communicate in FDD mode on the target uplink and downlink channels. As such, a difference between the data throughput of the uplink direction and a preset throughput threshold is the largest. A difference between the data throughput of the downlink direction and another preset throughput threshold is also the largest.

For example, in the first scenario, the data throughput of the uplink direction may be greater than a preset throughput threshold and the data throughput of the downlink direction may be greater than another preset throughput threshold. In the third scenario, the data throughput of the uplink direction may be greater than a preset throughput threshold and the data throughput of the downlink direction may be greater than another preset throughput threshold. In other scenarios, the data throughput of the uplink direction may be less than a preset throughput threshold and the data throughput of the downlink direction may be less than another preset throughput threshold. However, the extent to which the throughput of the uplink direction is greater than a preset throughput threshold in the first scenario may be different from the extent to which the throughput of the uplink direction is greater than the other preset throughput threshold in the third scenario.

In addition, the extent to which the throughput of the downlink direction is greater than a preset throughput threshold in the first scenario may be different from the extent to which the throughput of the downlink direction is greater than another preset throughput threshold in the third scenario. In the third scenario, when a difference between the throughput of the uplink direction and a preset throughput is maximal, that is, the extent to which the throughput of the uplink direction is greater than the preset throughput threshold in the third scenario is maximal, and a difference between the throughput of the downlink direction and another preset throughput is maximal, that is, the extent to which the throughput of the downlink direction is greater than the other preset throughput threshold in the third scenario is maximal, the 2.4G frequency band may be determined as the target uplink channel, the 24G frequency band may be determined as the target downlink channel, namely, the 2.4G frequency band may be the optimal uplink channel and the 24G frequency band may be the optimal downlink channel when the parties communicate in FDD mode.

In some embodiments, a target uplink channel and a target downlink channel may be determined from the at least one communication channel. As such, for communication between the parties in FDD mode on the target uplink and target downlink channels, the data throughput of the uplink direction is greater than a first preset value, the data throughput of the downlink direction is greater than a second preset value, and the margin of the data throughput in the uplink direction is maximal and the margin of the data throughput in the downlink direction is maximal.

Specifically, another method to determine a target uplink channel and a target downlink channel may include ensuring that the throughput of an uplink direction is equal to or similar to the throughput of a downlink direction, and making the throughput maximized. For example, in regard to the above six scenarios, when the difference between the throughputs of the uplink direction and the downlink direction in the third scenario is within a preset range compared to other scenarios, it may indicate that the throughputs of the uplink direction and the downlink direction in the third scenario may be equal or similar, and the data throughput of the uplink direction may be maximal and the data throughput of the downlink direction may also be maximal. Then, the 2.4G frequency band may be determined as the target uplink channel, and the 24G frequency band may be determined as the target downlink channel, namely, the 2.4G frequency band may be the optimal uplink channel and the 24G frequency band may be the optimal downlink channel for communication between the parties in FDD mode.

In some embodiments, an uplink channel and a downlink channel may be determined from the at least one communication channel. The signal-to-noise ratio or data throughput of the uplink direction may be determined according to channel parameters of the uplink channel. The signal-to-noise ratio or data throughput of the downlink direction may be determined according to channel parameters of the downlink channel. The target uplink channel and the target downlink channel may be determined while the maximum data throughput is satisfied. Consequently, the communication quality between the parties in FDD mode on the target uplink and downlink channels may be optimized.

In some embodiments, a first communication terminal performs duplex communication with a second communication terminal in FDD mode on an unlicensed frequency band. The first communication terminal and second communication terminal may be any two of a UAV, a remote control device, or a ground base station. The first communication terminal and second communication terminal may also be any of a UAV-UAV group, a remote control device-remote control device group, or a ground base station-ground base station group.

Specifically, when the first communication terminal performs duplex communication with the second communication terminal in FDD mode on the 2.4G frequency band and 5G frequency band, the situations may include the following.

In one situation, the 2.4G frequency band may be used as the uplink channel and the 5G frequency band may be used as the downlink channel at the first communication terminal. The first communication terminal performs duplex communication with the second communication terminal in FDD mode.

In another situation, the 2.4G frequency band may be used as the downlink channel and the 5G frequency band may be used as the uplink channel at the first communication terminal. The first communication terminal performs duplex communication with the second communication terminal in FDD mode.

In some embodiments, a first communication terminal may perform duplex communication with a second communication terminal in FDD mode on an unlicensed frequency band. Compared with the current technology for duplex communication between two parties in TDD mode on an unlicensed frequency band, the resource of an unlicensed frequency band may be fully used in FDD mode and the resource utilization rate of the unlicensed frequency band may be improved.

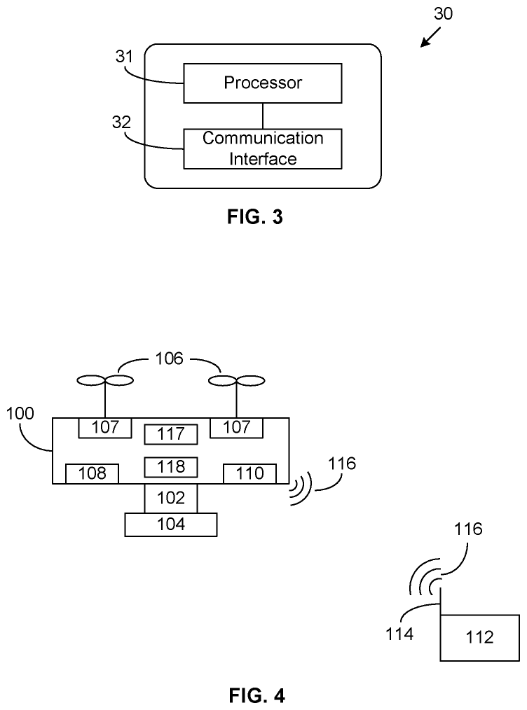

The present disclosure provides a communication device. FIG. 3 schematically shows a structural block diagram of a communication device 30 consistent with the present disclosure. As shown in FIG. 3, the communication device 30 may include one or more processors 31 that may work individually or cooperatively and a communication interface 32. The communication interface 32 may be used for communicating with a correspondent node device and may specifically be a wireless communication interface.

The processor 31 may be configured to obtain channel parameters of at least one communication channel between communication parties; according to the channel parameters of the at least one communication channel, determine the first measurement parameter of communication quality for communication between the parties in TDD mode, and the second measurement parameter of communication quality for communication between the parties in FDD mode; and determine whether the parties use TDD mode or FDD mode for communication based on the first and second measurement parameters.

The channel parameters of a communication channel may include at least one of the maximum transmit power of the communication channel, the path loss of the communication channel, or the interference level of the communication channel.

The at least one communication channel may be a frequency band or frequency point on an unlicensed frequency band. The communication terminal parties may be any two of a UAV, a remote control device, or a ground base station. The communication parties may also be any of a UAV-UAV group, a remote control device-remote control device group, or a ground base station-ground base station group.

The specific principles and implementation methods of the communication device provided in the embodiment are similar to those described in the embodiments shown in FIG. 1 and thus are not repeated here.

In some embodiments, channel parameters of at least one communication channel between two communication parties may be obtained by one of the communication parties. Based on the channel parameters of the at least one communication channel, the first measurement parameter of communication quality for communication between the parties in TDD mode may be determined, and the second measurement parameter of communication quality for communication between the parties in FDD mode may be determined. By comparing the first measurement parameter and the second measurement parameter, it may be determined whether the parties communicate using TDD mode or FDD mode. Hence, the duplex mode currently adopted by the parties may be switched to a duplex mode with higher communication quality, and the resource of an unlicensed frequency band may be fully utilized to improve the resource utilization rate of the unlicensed frequency band.

As shown in FIG. 3, the processor 31 may be arranged to determine the first measurement parameter of communication quality for communication between the parties in TDD mode according to channel parameters of the at least one communication channel. Then, according to the maximum transmit power, path loss, and interference level of each communication channel of the at least one communication channel, the processor 31 may determine the signal-to-noise ratio for communication between the parties in TDD mode on each communication channel.

The processor 31 may also be arranged to determine a target channel from the at least one communication channel so that the signal-to-noise ratio may be maximal for communication between the parties in TDD mode on the target channel.

According to the channel parameters of the at least one communication channel, the processor 31 may be arranged to determine the first measurement parameter of the communication quality for communication between the parties in TDD mode. Specifically, according to the maximum transmit power, path loss, interference level, and duty ratio of each of the at least one communication channel, the processor 31 may determine the throughput for communication between the parties in TDD mode on each communication channel.

In some embodiments, the processor 31 may also be arranged to determine a target channel from the at least one communication channel so that the throughput is maximal for communication between the parties in TDD mode on the target channel.

In some embodiments, the processor 31 may also be arranged to determine the duty cycle of an uplink direction and the duty cycle of a downlink direction on each communication channel so that the throughput is maximal when the parties communicate in TDD mode on the communication channel.

In some embodiments, a target channel may be determined from multiple communication channels by calculating signal-to-noise ratios or throughputs of the multiple communication channels. The signal-to-noise ratio may be maximal for communication between the parties in TDD mode on the target channel. In addition, the optimal duty ratio of the target channel may be determined by adjusting the duty ratio of the target channel so that the communication quality between the parties is further optimized. Thus, the target channel and the optimal duty ratio of the target channel may be determined and the communication quality for communication between the parties in TDD mode may be optimal.

As shown in FIG. 3, according channel parameters of at least one communication channel, the processor 31 may be arranged to determine the second measurement parameter of communication quality for communication between the parties in FDD mode. Specifically, the processor 31 may be arranged to select an uplink channel and a downlink channel from the at least one communication channel, wherein the parties communicate in FDD mode on the uplink and downlink channels; determine the signal-to-noise ratio of an uplink direction according to the channel parameters of the uplink channel; and determine the signal-to-noise ratio of a downlink direction according to the channel parameters of the downlink channel.

In some embodiments, the processor 31 may also be arranged to determine a target uplink channel and a target downlink channel from the at least one communication channel. When the communication parties communicate in FDD mode on the target uplink channel and the target downlink channel, the difference between the signal-to-noise ratio of an uplink direction and a preset signal-to-noise ratio threshold may be maximal, and the difference between the signal-to-noise ratio of a downlink direction and another preset signal-to-noise ratio threshold value may also be maximal.

In some embodiments, the processor 31 may also be arranged to determine a target uplink channel and a target downlink channel from at least one communication channel. When the communication parties communicate in FDD mode on the target uplink channel and the target downlink channel, the difference between signal-to-noise ratios of the uplink direction and the downlink direction may be within a preset range, and both the data throughput of the uplink direction and the data throughput of the downlink direction may be maximal.

According to channel parameters of the at least one communication channel, the processor 31 may be arranged to determine the second measurement parameter of communication quality for communication between the parties in FDD mode. Specifically, the processor 31 may be arranged to select an uplink channel and a downlink channel from the at least one communication channel, wherein the parties communicate in FDD mode on the uplink and downlink channels; determine the data throughput of an uplink direction according to the channel parameters of the uplink channel; and determine the data throughput of a downlink direction according to the channel parameters of the downlink channel.

In some embodiments, the processor 31 may also be arranged to determine a target uplink channel and a target downlink channel from at least one communication channel. When the communication parties communicate in FDD mode on the target uplink channel and the target downlink channel, the difference between the data throughput of an uplink direction and a preset data throughput threshold may be maximal, and the difference between the data throughput of a downlink direction and another preset data throughput threshold may also be maximal.

In some embodiments, the processor 31 may be arranged to determine a target uplink channel and a target downlink channel from at least one communication channel. As such, for communication between parties in FDD mode on the target uplink and downlink channels, the data throughput of an uplink direction is greater than a first preset value, the data throughput of a downlink direction is greater than a second preset value, and the margin of the data throughput of the uplink direction is maximal and the margin of the data throughput of the downlink direction is maximal. Specifically, the margin of the data throughput may be judged according to the ratio of the throughput and a corresponding preset value. That is, when the ratio of the data throughput of the uplink direction and the first preset value is relatively large, the maximum margin of the throughput of the uplink direction may be slightly larger. When the ratio of the data throughput of the uplink direction and the first preset value is relatively small, the maximum margin of the throughput of the uplink direction may be slightly smaller. Similarly, when the ratio of the data throughput of the downlink direction and the second preset value is relatively large, the maximum margin of the throughput of the downlink direction may be slightly larger. When the ratio of the data throughput of the downlink direction and the second preset value is relatively small, the maximum margin of the throughput of the downlink direction may be slightly smaller.

In some embodiments, an uplink channel and a downlink channel may be determined from at least one communication channel. The signal-to-noise ratio or data throughput of an uplink direction may be determined according to channel parameters of the uplink channel. The signal-to-noise ratio or data throughput of a downlink direction may be determined according to channel parameters of the downlink channel. A target uplink channel and a target downlink channel may be determined while the maximum data throughput is satisfied. Consequently, the communication quality between the parties in FDD mode on the target uplink and downlink channels may be optimized.

The present disclosure provides a communication device. The communication device may include one or more processors that may work individually or cooperatively. The one or more processors may be arranged to perform duplex communication with a correspondent node device in FDD mode on an unlicensed frequency band.

The one or more processors may use FDD mode to perform duplex communication with a correspondent node device on an unlicensed frequency band. Specifically, the one or more processors may use FDD mode on the 2.4G frequency band and 5G frequency band to perform duplex communication with the correspondent node device.

When the one or more processors use FDD mode on the 2.4G frequency band and 5G frequency band to perform duplex communication with the correspondent node device, the one or more processors specifically may determine the 2.4G frequency band as the uplink channel, determine the 5G frequency band as the downlink channel, and use FDD mode to perform duplex communication with the correspondent node device.

In some embodiments, when the one or more processors use FDD mode on the 2.4G frequency band and 5G frequency band to perform duplex communication with a correspondent node device, the one or more processors specifically may determine the 2.4G frequency band as the downlink channel, determine the 5G frequency band as the uplink channel, and use FDD mode to perform duplex communication with the correspondent node device.

The communication device and the correspondent node device may be any two of a UAV, a remote control device, or a ground base station. The communication device and the correspondent node device may also be any of a UAV-UAV group, a remote control device-remote control device group, or a ground base station-ground base station group.

In some embodiments, duplex communication with a correspondent node device is performed in FDD mode on an unlicensed frequency band by a communication device. Compared with duplex communication in TDD mode on an unlicensed frequency band with current technologies, FDD mode may make full use of the resource of an unlicensed frequency band and improve the resource utilization rate of the unlicensed frequency band.

The present disclosure also provides a UAV. FIG. 4 schematically shows a structural block diagram of a UAV 100 consistent with the present disclosure. As shown in FIG. 4, the UAV 100 may include a fuselage, a power system (not labeled), and a flight controller 118. The power system may include at least one of a motor 107, a propeller 106, or an electronic speed regulator 117. The power system is mounted on the fuselage to provide flight power. The flight controller 118 is in communication connection with the power system for controlling flight of the UAV. The flight controller 118 may include an inertial measurement unit (IMU) that may contain a gyroscope and an accelerometer. The IMU may be used for detecting the pitch angle, roll angle, yaw angle, and acceleration of the UAV 100.

In addition, as shown in FIG. 4, the UAV 100 may also include a sensing system 108, a communication system 110, a supporting device 102, and a photographing device 104. The support device 102 specifically may be a gimbal and the communication system 110 may specifically include a receiver. The receiver may be used for receiving wireless signals transmitted by an antenna 114 of a ground station 112. A numerical 116 may represent electromagnetic waves generated during a communication process between the receiver and the antenna 114.

When the UAV 100 and the ground station 112 wirelessly communicate, the flight controller 118 may control the communication mode between the UAV 100 and the ground station 112 according to channel parameters of a wireless channel between the UAV 100 and the ground station 112. The specific principles and realization methods are similar to those in the above-illustrated embodiments, and thus they are not repeated here.

In some embodiments, channel parameters of at least one communication channel between two communication parties may be obtained by a UAV. Based on the channel parameters of the at least one communication channel, the first measurement parameter of communication quality for communication between the parties in TDD mode may be determined, and the second measurement parameter of communication quality for communication between the parties in FDD mode may be determined as well. By comparing the first measurement parameter and the second measurement parameter, it may be determined that the parties communicate using TDD mode or FDD mode. Hence, the duplex mode currently adopted by the parties may be switched to a duplex mode with higher communication quality, and the resource of an unlicensed frequency band may be fully utilized to improve the resource utilization rate of the unlicensed frequency band.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The integrated unit may be implemented in the form of hardware. The integrated unit may also be implemented in the form of hardware plus software functional units.

The integrated unit implemented in the form of software functional unit may be stored in a non-transitory computer-readable storage medium. The software functional units may be stored in a storage medium. The software functional units may include instructions that enable a computer device, such as a personal computer, a server, or a network device, or a processor to perform part of a method consistent with embodiments of the present disclosure, such as each of the exemplary methods described above. The storage medium may include any medium that can store program codes, for example, a USB disk, a mobile hard disk, a read-only memory (ROM), a random access memory (RAM), a magnetic disk, or an optical disk.

People skilled in the art may understand that for convenient and concise descriptions, above examples and illustrations are based only on the functional modules. In practical applications, the functions may be distributed to and implemented by different functional modules according to the need. That is, the internal structure of a device may be divided into different functional modules to implement all or partial functions described above. The specific operational process of a device described above may refer to the corresponding process in the embodiments described above, and no further details are illustrated herein.

Further, it should be noted that the above embodiments are used only to illustrate the technical solutions of the present disclosure and not to limit it to the present disclosure. Although the present disclosure is described in detail in the light of the foregoing embodiments, those of ordinary skill in the art should understand that they can still modify the technical solutions recorded in the preceding embodiments, or they can perform equivalent replacements for some or all of the technical features. The modifications or substitutions, however, do not make the nature of the corresponding technical solutions out of the scope of the technical solutions of each embodiment of the present disclosure.

What is claimed is:

1. A communication mode control method for a communication device, comprising:
obtaining a channel parameter of at least one communication channel between two communication parties;
according to the channel parameter of the at least one communication channel, determining a first measurement parameter of communication quality for communication between the communication parties using a time division duplex mode, and determining a second measurement parameter of communication quality for communication between the communication parties using a frequency division duplex mode; and
according to the first measurement parameter and the second measurement parameter, determining whether the communication parties communicate using the time division duplex mode or the frequency division duplex mode.

2. The method according to claim 1, wherein the channel parameter comprises at least one of a maximum transmit power of the at least one communication channel, a path loss of the at least one communication channel, and an interference level of the at least one communication channel.

3. The method of claim according to claim 2, wherein determining the first measurement parameter of communication quality for communication between the communication parties using the time division duplex mode includes:
according to the maximum transmit power, the path loss, and the interference level of each of the at least one communication channel, determining a signal-to-noise ratio for communication between the communication parties using the time division duplex mode on each of the at least one communication channel.

4. The method according to claim 3, further comprising:
determining a target channel from the at least one communication channel so that the signal-to-noise ratio is maximal for communication between the communication parties using the time division duplex mode on the target channel.

5. The method according to claim 2, wherein determining the first measurement parameter of communication quality for communication between the communication parties using the time division duplex mode includes:
according to the maximum transmit power, the path loss, and the interference level of each of the at least one communication channel, determining a throughput for communication between the communication parties using the time division duplex mode on each communication channel.

6. The method according to claim 5, further comprising:
determining a target channel from the at least one communication channel so that the throughput is maximal for communication between the communication parties using the time division duplex mode on the target channel.

7. The method according to claim 2, wherein determining the second measurement parameter of communication quality for communication between the communication parties using the frequency division duplex mode includes:
selecting an uplink channel and a downlink channel from the at least one communication channel, the communication parties communicating using the frequency division duplex mode on the uplink channel and the downlink channel;
determining a signal-to-noise ratio of an uplink direction according to a channel parameter of the uplink channel; and
determining a signal-to-noise ratio of a downlink direction according to a channel parameter of the downlink channel.

8. The method according to claim 7, further comprising:
determining a target uplink channel and a target downlink from the at least one communication channel so that for communication between the communication parties using the frequency division duplex mode on the target uplink channel and the target downlink channel, a difference between a signal-to-noise ratio of the uplink direction and a preset signal-to-noise ratio threshold value is maximal, and a difference between a signal-to-noise ratio of the downlink direction and another preset signal-to-noise ratio threshold value is maximal.

9. The method according to claim 7, further comprising:
determining a target uplink channel and a target downlink channel from the at least one communication channel so that for communication between the communication parties using the frequency division duplex mode on the target uplink channel and target downlink channel, a difference between a signal-to-noise ratio of the uplink direction and a signal-to-noise ratio of the downlink direction is within a predetermined range, and a data throughput of the uplink direction is maximal, a data throughput of the downlink direction is maximal.

10. The method according to claim 1, wherein the at least one communication channel is a frequency band or frequency point of an unlicensed band.

11. A communication device, comprising:
one or more processors, the one or more processors working individually or cooperatively and operable when executing program instructions to:
obtain a channel parameter of at least one communication channel between two communication parties;
according to the channel parameter of the at least one communication channel, determine a first measurement parameter of communication quality for communication between the communication parties using a time division duplex mode, determine a second measurement parameter of communication quality for communication between the communication parties using a frequency division duplex mode; and
according to the first measurement parameter and the second measurement parameter, determine whether the communication parties communicate using the time division duplex mode or the frequency division duplex mode.

12. The device according to claim 11, wherein the channel parameter comprises at least one of a maximum transmit power of the at least one communication channel, a path loss of the at least one communication channel, or an interference level of the at least one communication channel.

13. The device according to claim 12, wherein according to the channel parameter of the at least one communication channel, when determining the first measurement parameter of communication quality for communication between the communication using the time division duplex mode, the one or more processors are further configured to execute the program instructions to:
according to the maximum transmit power, the path loss, and the interference level of each of the at least one communication channel, determine a signal-to-noise ratio for communication between the communication parties using the time division duplex mode on each of the at least one communication channel.

14. The device according to claim 13, wherein the one or more processors are further configured to execute the program instructions to:
determine a target channel from the at least one communication channel so that the signal-to-noise ratio is maximal for communication between the communication parties using the time division duplex mode on the target channel.

15. The device according to claim 12, wherein according to the channel parameter of the at least one communication channel, when determining the first measurement parameter of communication quality for communication between the communication parties using the time division duplex mode, the one or more processors are further configured to execute the program instructions to:
according to the maximum transmit power, the path loss, and the interference level of each of the at least one communication channel, determine a throughput for communication between the communication parties using the time division duplex mode on each communication channel.

16. The device according to claim 15, wherein the one or more processors are further configured to execute the program instructions to:
determine a target channel from the at least one communication channel so that the throughput is maximal for communication between the communication parties using the time division duplex mode on the target channel.

17. The device according to claim 12, wherein according to the channel parameter of the at least one communication channel, when determining the second measurement parameter of communication quality for communication between the communication parties using the frequency division duplex mode, the one or more processors are further configured to execute the program instructions to:
select an uplink channel and a downlink channel from the at least one communication channel, the communication parties communicating using the frequency division duplex mode on the uplink channel and the downlink channel;
determine a signal-to-noise ratio of an uplink direction according to a channel parameter of the uplink channel; and
determine a signal-to-noise ratio of a downlink direction according to a channel parameter of the downlink channel.

18. The device according to claim 17, wherein the one or more processors are further configured to execute the program instructions to:
determine a target uplink channel and a target downlink from the at least one communication channel so that for communication between the communication parties using the frequency division duplex mode on the target uplink channel and target downlink channel, a difference between a signal-to-noise ratio of the uplink direction and a preset signal-to-noise ratio threshold value is maximal, and a difference between a signal-to-noise ratio of the downlink direction and another preset signal-to-noise ratio threshold value is maximal.

19. The device according to claim 17, wherein the one or more processors are further configured to execute the program instructions to:
determine a target uplink channel and a target downlink from the at least one communication channel so that for communication between the communication using the frequency division duplex mode on the target uplink channel and target downlink channel, a difference between a signal-to-noise ratio of the uplink direction and a signal-to-noise ratio of the downlink direction is within a predetermined range, a data throughput of the uplink direction is maximal, and a data throughput of the downlink direction is maximal.

20. The device according to claim 11, wherein the at least one communication channel is a frequency band or frequency point of an unlicensed band.
